(19) United States
(12) Patent Application Publication
(10) Pub. No.: US 2010/0235769 A1
(43) Pub. Date: Sep. 16, 2010

(54) SMOOTH LAYOUT ANIMATION OF CONTINUOUS AND NON-CONTINUOUS PROPERTIES

(75) Inventors: Kenneth L. Young, Sammamish, WA (US); Steven C. White, Redmond, WA (US); Kurt B. Jacob, Redmond, WA (US); Christian Schormann, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/405,213

(22) Filed: Mar. 16, 2009

(51) Int. Cl. G06F 3/048

(52) U.S. Cl. 715/764

(57) ABSTRACT

A layout animation system is described herein that performs smooth transitions for properties of a layout, regardless of whether the layout properties are discrete or automatically calculated. Before a transition is executed, the layout animation system extracts and stores the positioning, sizing, and visibility of participating elements across the layout hierarchy. The system places the affected elements in the same position, size, and visibility as the outgoing state requests and animates the elements to an incoming state. For each element, the system calculates a smooth animation that transforms the element from the outgoing position, size, and visibility to the incoming position, size, and visibility. The system then animates the elements over a desired transition time. Thus, the layout animation system provides the ability to create smooth layout transitions in the presence of automatic layout management for properties of various types.

### BACKGROUND

Modern user interface toolkits use layout managers to create user interfaces that can be dynamically resized. Layout managers are software components that have the ability to lay out components (sometimes called widgets) by their relative positions without using distance units. It is often more natural to define component layouts in this manner than to define component positions in pixels or common distance units, so a number of popular widget toolkits include this ability by default. Widget toolkits often allow designers to place widgets in layout containers that have particular layout characteristics when the container is rendered. Windows Presentation Foundation (WPF) and Microsoft Silverlight are two examples of toolkits that provide layout managers. Designers describe user interface (UI) components in Extensible Application Markup Language (XAML) and can define UI states and transitions using an Application Programming Interface (API) such as Microsoft Visual State Manager.

One reason that layout managers are used is to enable automatic resizing of an application, so that UIs can work properly on devices with different display resolutions and with resizable, reconfigurable windows. Layout managers are used to automatically determine the layout of graphical elements and controls on a screen. Layout managers typically operate by forcing their children (graphical elements, UI elements) to conform to a certain layout rule. A stack panel, for example, may force its children into a horizontal or vertical stack, controlling only relative position of the objects with respect to each other. As another example, a uniform grid might force objects to be arranged in a grid, with a fixed size for each child. A table-style layout might force children to conform to row and column definitions, and to define position margins to control positioning and size.

For dynamic user interfaces, it is often useful to transition between different layouts of UI components. For example, when a user clicks on a “More” button the designer may want the area of one component to expand and display more UI controls. For usability reasons, designers like transitions to be smooth and allow for detailed control. In some scenarios, it is sufficient to simply fade between two entirely different UI screens, but this technique does not work when a layout of graphical elements or user interface controls is designed to morph smoothly from one layout to another. For example, a designer may want a panel to appear to fly out from the left side after a user logs in to an application. Current animation systems, such as Microsoft Visual State Manager, automatically animate transitions from one state to another. In the previous example, the animation system causes the panel to animate from the left side of the display through several intermediate locations before reaching the final fully displayed location.

These automatic transitions work well for continuous properties that the animation system can easily vary between two values. For example, an animation system can easily vary opacity that starts at 0% in a first state and ends up at 100% in a second state using intermediate values (e.g., 20%, 40%, and 80%). Unfortunately, many of the properties that define layout in the presence of layout managers are discrete (e.g., changing a column number of a grid) or may even have values that are automatically calculated (e.g., setting a row width to “auto”). Smooth layout transitions (i.e., morphs) between layouts in the presence of such discrete properties are difficult to achieve with current technology. Animation of such properties is either impossible or results in sudden layout switches rather than smooth transitions. Current animation systems cannot smoothly animate transitions for these types of properties.

### SUMMARY

A layout animation system is described herein that performs smooth transitions for properties of a layout, regardless of whether the layout properties are discrete or automatically calculated. The layout animation system solves the problem of morphing between two given layout states that contain changes to non-continuous properties by extracting the geometric information of the elements in each of the participating layout states. Before a transition is executed, the layout animation system extracts and stores the positioning, sizing, and visibility of participating elements across the layout hierarchy. The system first places the affected elements in the same position, size, and visibility as the outgoing state requests. For each element, the system calculates a smooth animation that transforms the element from the outgoing position, size, and visibility to the incoming position, size, and visibility. For visibility, care is taken to introduce smooth fade-in animations using additional opacity animation. The system then animates the elements over a desired transition time. Thus, the layout animation system provides the ability to create smooth layout transitions in the presence of automatic layout management for properties of various types.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the layout animation system, in one embodiment.

FIG. 2 is a display diagram that illustrates the animation of a UI element performed by the system, in one embodiment.

FIG. 3 is a flow diagram that illustrates the processing of the system to identify potential target UI elements that may move during a particular state transition, in one embodiment.

FIG. 4 is a flow diagram that illustrates the processing of the system to smoothly animate the transition of a UI element from an outgoing state to an incoming state, in one embodiment.

### DETAILED DESCRIPTION

A layout animation system is described herein that performs smooth transitions for properties of a layout, regardless of whether the layout properties are discrete or automatically calculated. An example of a discrete property is visibility. A UI element might be visible in one state and invisible in another. The layout animation system solves the problem of morphing between two given layout states by extracting the geometric information of the elements in each of the participating layout states. During the execution of a layout transition, the participating UI elements are taken out of the control of their layout managers (e.g., by adding an extra layer of layout that compensates for what the layout manager is doing to animate the UI elements) and animated by the layout animation system directly on a display surface without layout management. Once the elements have reached their destination location and size, the system returns the elements to their place in the layout system, and the layout system takes control again. Thus, the layout animation system provides the ability to create smooth layout transitions in the presence of automatic layout management for properties of various types.

The layout animation system manages transitions as follows. Before a transition (or morph) is executed, the layout animation system extracts and stores the positioning, sizing, and visibility of all participating elements (both primitives, such as graphical elements and controls, and layout containers) across the layout hierarchy in parent-relative coordinates. When the transition is executed, the system may wrap each element that changes a layout property (e.g., size, position, visibility, and so forth) in a drawing container without layout management (in WPF, a Canvas, for example) so that the system can smoothly animate the element (e.g., by gradually varying the Left and Top coordinates relative to the Canvas because those properties are floating point numbers). Alternatively or additionally, the system may request that the layout manager not broadcast new size/position information to containers of elements while the layout animation is in progress (or store such elements in a layout exceptions list). The system first places the affected elements in the same position, size, and visibility as the outgoing state requests. In some embodiments, this step may be performed by a traditional layout manager before the system intervenes to provide smooth animation. For each element, the system calculates a smooth animation that transforms the element from the outgoing position, size, and visibility to the incoming position, size, and visibility. For visibility, care is taken to introduce smooth fade-in animations using additional opacity animation. The system then animates the elements over a desired transition time. After the elements have reached the destination position, the system places the elements back into the appropriate layout containers. Then, the layout animation system releases control of the participating elements, and behavior is again controlled by the layout managers.

Discrete or calculated properties can include various UI element settings. For example, a grid layout may include row and column identifiers rather than coordinates where UI elements are located. A transition of a UI element from one column to another between two states is a discrete property change (e.g., Grid.Column), but may actually move the element some distance as well as changing the element's width and/or height. Although the column property is changing between the states, the layout animation system modifies the position and size properties of the element through several intermediate positions between the start and final location of the element so that the animation is smooth. An example of a calculated property value is changing a height property of an element from an explicit height to a value of “auto” that indicates that the height of the element dynamically adjusts based on other elements around the element. There is no gradual modification native to the platform between, for example, a height of five and a value of auto. However, the layout animation system smoothly animates the transition by modifying the size property of the element.

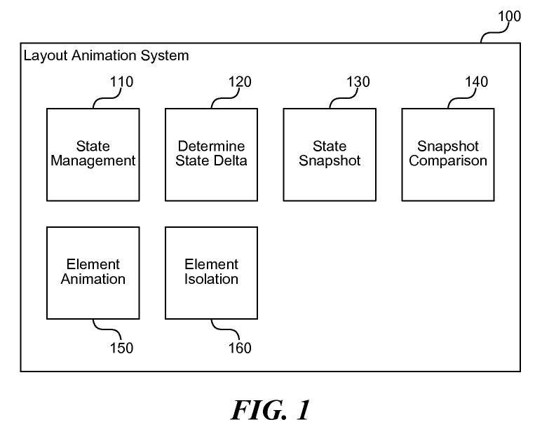

FIG. 1 is a block diagram that illustrates components of the layout animation system, in one embodiment. The layout animation system 100 includes a state management component 110, a determine state delta component 120, a state snapshot component 130, a snapshot comparison component 140, an element animation component 150, and an element isolation component 160. Each of these components is described in further detail herein.

The state management component 110 stores multiple states in which a UI can exist and receives an indication to transition from one state to another. The states may be stored in a declarative format, such as a XAML file. Designers may create states by visually laying controls on a canvas in a designer tool or may manually add control definitions to the declarative format file. The declarative format may also contain transition information, such as the conditions that cause a transition (e.g., mouse hover, button click, and so forth) and properties of the transition (e.g., a duration). For example, these may be stored as Triggers and/or VisualStates in a XAML file using Microsoft's Visual State Manager. Transitions may be caused by application logic based on a variety of purposes for different applications.

The determine state delta component 120 compares an ingoing and outgoing state to determine the layout properties that change between the states, and the corresponding UI elements that will change. The layout properties may include many different property types, such as columns and rows of a grid layout (and column spans and row spans), top and left properties of a canvas, a visibility property, an orientation of a stack, a docking direction in a dock layout, an expanded property of an expander layout, orientation and item width/height of a wrap panel layout, and individual element positional properties (e.g., width, height, minimum width, minimum height, maximum width, maximum height, margins, padding, horizontal alignment, and vertical alignment). When the determine state delta component 120 determines that layout properties of a UI element change during the transition, the determine state delta component 120 also adds parent and sibling elements of the element to a set of elements that change since these elements may be repositioned as well, due to the new parameters of the element whose layout properties are changing. It is typically unnecessary to handle child elements because they typically change automatically when their parents change, and child elements can construct layout animations of their own for any cases that turn out to be complex.

The state snapshot component 130 takes a snapshot of the rectangle in which each UI element of a layout is positioned. The rectangle is an abstract boundary of the UI element representing the element's dimensions that is not actually visible. Note that the system can also be used to handle three-dimensional animations, so rather than a rectangle the snapshot may include a bounding box. The state snapshot component 130 takes two snapshots, one after informing the UI element that it is in the outgoing state and another after informing the UI element that it is in the incoming state. In some embodiments, the layout animation system provides APIs for requesting that a UI element change states without actually rendering the UI element.

The snapshot comparison component 140 compares the snapshots of the incoming state and outgoing state to determine what UI elements actually change. For each element, the snapshot comparison component 140 determines the value of each property that changed in each of the incoming and outgoing states, and then determines an appropriate property for the element animation component 150 to modify to animate the transition of that property. For example, for the visibility property, the snapshot comparison component 140 may determine that opacity is an appropriate property to modify through several intermediate states to create a smooth transition between the outgoing and incoming layout states. During the transition animation, the system modifies the opacity property, and at the final animation to the incoming state, the system modifies the visibility property to its discrete value (e.g., false, for not visible) and resets the opacity property to its original value.

The determine state delta component 120 and the snapshot comparison component 140 perform similar functions under different conditions. The determine state delta component 120 compares states before a transition occurs to provide an estimate of the layout properties that will change during the transition. However, without actually performing the transition, the determine state delta component 120 may actually be over inclusive in the UI elements that it identifies as changing. The snapshot comparison component 140, on the other hand, compares snapshots of the layout properties when each state is active. The starting snapshot is taken at a time when the outgoing state is active, and the ending snapshot is taken after the transition to the incoming state has been made (e.g., the transition occurs in memory, though it is not yet rendered to the screen). The snapshot comparison component 140 then passes those UI elements that actually changed to the element animation component 150 to smoothly animate the transition, and passes any additional UI elements that did not actually change through a traditional layout path. In addition, a traditional (non-layout) animation path may animate any properties that are changing in the state delta that do not have layout repercussions (e.g., background color).

The element animation component 150 animates an element smoothly between the outgoing state and incoming state. For example, if an element starts at one position and moves to another, then the element animation component 150 moves the element from the start position to the end position through several intermediate positions in between to provide the appearance of smooth movement to the user. Although rectangles and rectangular coordinates are used as examples herein, those of ordinary skill in the art will recognize that the system can be used with various types of coordinates and transition motion. For example, the system may use a polar coordinate system where elements are animated through a rotation angle. As another example, a particular UI layout may define a winding path along which UI elements move to get from the outgoing state to the incoming state.

In some embodiments, the layout animation system 100 includes an element isolation component 160 that isolates the movement of the element from other elements. Because a layout manager dynamically determines element layout and position, changing the size and position of one element may cause the layout of other elements to change. This may be undesirable in the context of transition animation, so the element isolation component 160 may create a temporary container that contains the element the element animation component 150 is animating. The element isolation component 160 sets the container's size and position based on the incoming state, and then animates the element within the container from its outgoing state position and size to its incoming state position and size. Because the container size and position does not change during the transition, other elements are unaffected by the animation. When the transition is complete, the element isolation component 160 removes the temporary container from the layout. Alternatively or additionally, the layout manager may provide a flag that the layout animation system sets to inform the manager that a particular set of changes to an element do not affect other elements.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

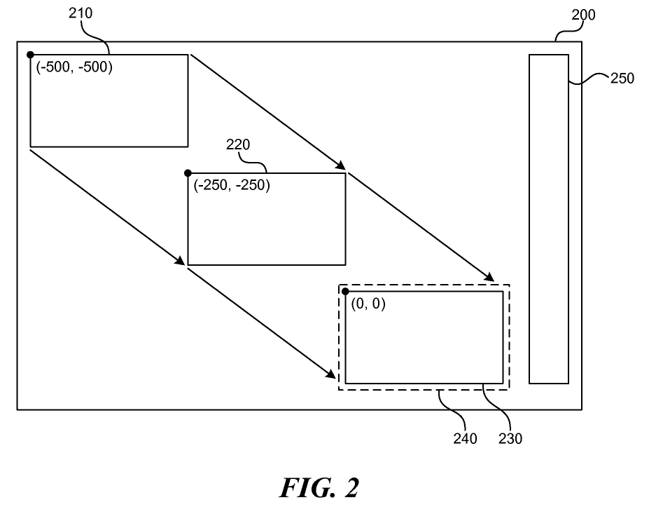

FIG. 2 is a display diagram that illustrates the animation of a UI element performed by the system, in one embodiment. A UI element starts at a starting position 210 in the outgoing state and ends at an ending position 230 in the incoming state. To animate the transition, the system first wraps the UI element at the ending position 230 with a temporary container 240. The temporary container 240 ensures that the movement of the UI element is isolated from the perspective of other elements, such as UI element 250. The ending position 230 of the UI element is considered coordinate (0,0) for purposes of the transition. Using the snapshot process described herein, the system determines that the starting position is at coordinates (−500, −500) relative to the container. Note that in a layout-based system, UI elements are not placed using geometric coordinates, and the behavior that causes the UI element to be initially at the starting position 210 and later at the ending position 230, may actually be a change in some property that has no associated coordinates. For example, a designer may change alignment properties from top-left to bottom-right to cause the movement from the starting position 210 to the ending position 230. There is no logical intermediate state for a property such as alignment. However, by taking a snapshot of the UI element's actual coordinates in the outgoing and incoming states, the system is able to smoothly animate the movement of the UI element based on the snapshot coordinates. Thus, the system animates the UI element through at least one intermediate position 220 so that the element appears to a user to smoothly move from the starting position 210 to the ending position 230.

The use of a temporary container 240 allows the system to animate just the UI element(s) of interest and not have other elements jumping erratically around the display. For example, if UI element 250 has a width set to “auto” so that it fills all available width, then the UI element 250 would reposition itself throughout the animation as the animated UI element moves from the starting position 210 to the intermediate position 220, and finally to the ending position 230. Instead, the temporary container 240 does not move during the animation so UI element 250 stays put. Moreover, UI element 250 may be going through its own layout animation because of the same layout change or even another layout change—and the system avoids any side effects from the current animation interfering with any other animations that are going on. When the transition animation is complete the system removes the temporary container 240 and the layout once again responds according to traditional layout rules unless a state transition occurs that invokes the layout animation system again.

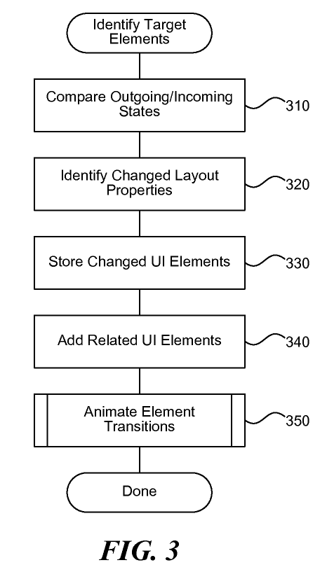

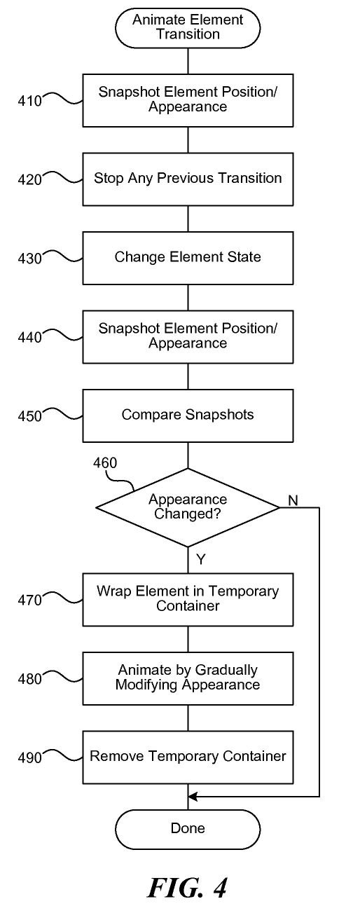

FIG. 3 is a flow diagram that illustrates the processing of the system to identify potential target UI elements that may move during a particular state transition, in one embodiment. Beginning in block 310, the system compares the outgoing state to the incoming state to determine any layout-based properties that are different. For example, the system may enumerate the layout properties and perform an equality or similar programmatic test on the value of each layout property in the outgoing and incoming state. Continuing in block 320, the system identifies the changed layout properties based on the comparison. Note that even though a layout property changes, a UI element may not actually move. For example, if an alignment property is changed from left to right, but the UI element is sandwiched between other elements its position may be the same with either alignment. This is acceptable, and one goal is for the system at this point to identify a set of UI elements that includes any element that will actually change layout, regardless of whether the system is over inclusive and includes some elements that turn out not to change. These sorts of elements will eventually be filtered out using the procedure described in FIG. 4.

Continuing in block 330, the system stores changed UI elements that have identified changing layout properties in a data structure. For example, the system may store the set of changed UI elements in an in memory list. Continuing in block 340, for each UI element identified, the system adds any related (e.g., sibling and parent) UI elements to the stored UI elements. Sibling and parent UI elements are commonly affected by a change in layout of a particular UI element. Child elements may also be included, though in many layout systems child elements will automatically and appropriately adapt to a layout change of the parent, so this may occur without further intervention by the system. Continuing in block 350, the system smoothly animates the transition of each identified UI element as described further with reference to FIG. 4. After block 350, these steps conclude.

FIG. 4 is a flow diagram that illustrates the processing of the system to smoothly animate the transition of a UI element from an outgoing state to an incoming state, in one embodiment. Beginning in block 410, the system takes a snapshot of the position and other visible properties of a UI element identified by the process described herein with reference to FIG. 3. Note that the system may perform these steps for each element identified by the previous process, and these steps may occur serially for each element or in parallel. The system may also store the UI element's effective opacity where effective opacity is visibility times opacity. In other words, if visibility is zero or false, the system may not store opacity, but if visibility is true then opacity gives a level of visibility and the system stores the opacity.

Continuing in block 420, the system stops any previously in progress transition. Because a layout UI is dynamic and users can interact with the UI, the system may be mid-transition of a previous state change when a new state change request is received. This is relatively common and just causes the system to animate the transition from the UI element's current position to the UI element's new ending position based on the new incoming state. Continuing in block 430, the system informs the UI element that the layout has changed to the new state. The system does this in a manner that the UI element updates all of its positional and layout properties but does not actually render a transition to the display. In this way, the system can access each of the UI element's properties at their ending values without yet showing any animation to the user.

Continuing in block 440, the system takes a snapshot of the position and other visible properties of the UI element now that the element is in the incoming state. This informs the system of where the UI element will end up when the animation is complete. The system may again store the UI element's effective opacity or may read it as needed from the element's current property values. Continuing in block 450, the system compares the two snapshots to determine whether the UI element moved or changed appearance in some manner (e.g., visibility, alignment). This system uses the comparison results to create a series of intermediate positions/appearances for the UI element to provide a smooth animation transition from the outgoing state to the incoming state.

Continuing in decision block 460, if the appearance of the UI element changed, then the system continues in block 470, else the system completes allowing the UI element to transition using traditional animation. Continuing in block 470, the system wraps the UI element in a temporary container (e.g., a canvas) that isolates the movement of the UI element during animation from other UI elements.

Continuing in block 480, the system animates the transition of the UI element by gradually modifying the values of appearance properties that simulate a change between the outgoing and incoming state in a way that makes the change of appearance of the UI element appear smooth to a user. The system translates from a level of abstraction where qualitative layout properties (e.g. alignment, column) are being animated to a level of abstraction where quantitative layout properties (e.g. width, height, x/y coordinates) are being animated. Inherent in that translation is that the former properties would appear jerky and are not conducive to a good user experience whereas the latter are smooth and are conducive to a good user experience. The system determines a number of intermediate appearances and a speed of transition between intermediate appearances in the series based on a specified duration for the transition between states. For colors the system may animate the red, green, and blue values gradually between the start and end color. In some embodiments, a traditional animation system and the layout animation system may run in parallel (not shown), with the traditional animation system handling non-layout property changes (e.g., color), and the layout animation system handling layout property changes (e.g., alignment). For layout property changes that modify the element's position, the system gradually modifies the coordinates of the UI element to produce smooth movement. For other properties, such as visibility, the system may modify a related property, such as opacity, to create an appearance of smoothly changing visibility.

Continuing in block 490, the system removes the temporary container from the UI element so that the UI element is placed back into its normal position in the layout hierarchy and so that any modifications to it will once again affect surrounding elements. After block 490, these steps conclude.

In some embodiments, the layout animation system invokes pluggable layout containers to perform animation of transitions. A particular container designer may want a type of movement between states other than the default described herein. The layout animation system asks the pluggable container for a start and end state, takes snapshots of the states, informs the container when the snapshots differ, and requests that the container perform the animation from the start state to the end state. The pluggable container may also provide a mapping from a changing layout property to an animation property (or properties) that the system uses for the transition resulting from the layout property.

In some embodiments, the layout animation system operates on some UI elements that use layout management alongside other UI elements that do not use layout management. For example, a UI may include elements positioned according to absolute coordinates alongside UI elements positioned relative to other UI elements. The system may animate changes to the relative positioned elements without affecting the absolute positioned elements. The system may also allow a designer to toggle smooth layout on or off for a particular state group, so that state groups with smooth layout on use the techniques described herein, and groups with smooth layout toggled off use traditional layout animation techniques.

In some embodiments, the layout animation system also takes care of transitions that are interrupted. It is possible to “redirect” a transition to a different morph target state at any given time. A UI layout may change to one state when a user toggles a button and another state when the user toggles the button again. If the user quickly toggles the button back and forth, then the layout may be mid-transition when the user's action reverses the transition. This system handles this smoothly by animating the layout according to the new final state by starting from the mid-transition position.

The following is an example of defining user interface elements along with states and transitions in XAML for use with Microsoft Silverlight. XAML UI elements are typically defined as:

<vsm:VisualStateManager.VisualStateGroups>
oneOrMoreVisualStateGroups
</vsm:VisualStateManager.VisualStateGroups>

The prefix vsm maps to the System.Windows namespace and assembly. For the prefix vsm, the mapping is declared as xmlns:vsm=“clr-namespace:System.Windows;assembly=System.Windows”.

The text “oneOrMoreVisualStateGroups” refers to one or more object elements of type VisualStateGroup. Designers add VisualStateGroup objects to the VisualStateManager.VisualStateGroups attached property to represent states of a control. Each VisualStateGroup contains a collection of mutually exclusive VisualState objects. Control authors transition between states by calling the VisualStateManager GoToState method. This separate allows designers (who may not have programming experience) to design user interfaces declaratively in XAML, while control authors that are programmers define logic behind the user interface of an application.

The following example creates a simple ControlTemplate for a Button that contains one Grid. The example sets the VisualStateManager.VisualStateGroups property on the Grid. The VisualStateManager.VisualStateGroups contains one VisualStateGroup, called CommonStates, which defines the MouseOver and Normal VisualState objects. When the user puts the mouse cursor over the Button, the Rectangle inside the Grid changes Visibility from Visible to Collapsed over one half second. When the user moves the mouse away from the button, the Rectangle reverts to Visible.

```
<ControlTemplate TargetType=“Button” xmlns:vsm=“clr-
    namespace:System.Windows;assembly=System.Windows”>
  <Grid >
    <vsm:VisualStateManager.VisualStateGroups>
      <vsm:VisualStateGroup x:Name=“CommonStates”>
        <vsm:VisualStateGroup.Transitions>
          <!--Take half second to trasition to the MouseOver state.-->
          <vsm:VisualTransition To=“MouseOver”
              GeneratedDuration=“0:0:0.5”/>
        </vsm:VisualStateGroup.Transitions>
        <vsm:VisualState x:Name=“Normal” />
        <!-Collapse the Rectangle when the
            mouse is over the button.-->
        <vsm:VisualState x:Name=“MouseOver”>
          <Storyboard>
            <objectAnimationUsingKeyFrames
                Storyboard.TargetName=“Rectangle1”
                Storyboard.TargetProperty=“UIElement.Visibility”>
              <DiscreteObjectKeyFrame KeyTime=”00:00:00”>
                <DiscreteObjectKeyFrame.Value>
                  <Visibilty>Collapsed</Visibility>
                </DiscreteObjectKeyFrame.Value>
              </DiscreteObjectKeyFrame>
            </ObjectAnimationUsingKeyFrames>
          </Storyboard>
        </vsm:VisualState>
      </vsm:VisualStateGroup>
    </vsm:VisualStateManager.VisualStateGroups>
    <vsm:VisualStateManager.CustomVisualStateManager>
      <Microsoft_Expression_Extensions_Animation:
          LayoutAwareVisualStateManager/>
    </vsm:VisualStateManager.CustomVisualStateManager>
    <Rectangle x:Name=”Rectangle1”/>
  </Grid>
</ControlTemplate>
```

From the foregoing, it will be appreciated that specific embodiments of the layout animation system have been described herein for purposes of illustration, but that various modifications may be made without deviating from the spirit and scope of the invention. Accordingly, the invention is not limited except as by the appended claims.

I/We claim:

1. A computer-implemented method for smoothly animating the transition of a user interface (UI) element from an outgoing state to an incoming state, the method comprising:
taking an outgoing snapshot of the position and other visible properties of a UI element in the outgoing state arranged by a layout manager;
informing the UI element that the layout has changed to the new state so that the UI element updates its positional and layout properties but does not render a transition;
taking an incoming snapshot of the position and other visible properties of the UI element in the incoming state;
comparing the outgoing snapshot and the incoming snapshot to determine whether the UI element moved or changed appearance; and
upon determining that the appearance or position of the UI element changed, animating the transition of the UI element by gradually modifying the values of appearance properties that simulate a change between the outgoing and incoming state to make the change of appearance of the UI element appear smooth to a user,
wherein the preceding steps are performed by at least one processor.

2. The method of claim 1 further comprising performing the method for multiple UI elements in parallel.

3. The method of claim 1 wherein taking a snapshot further comprises storing the UI element's effective opacity where effective opacity is visibility times opacity.

4. The method of claim 1 further comprising stopping any previously in progress transition.

5. The method of claim 1 wherein taking a snapshot of the outgoing state comprises taking a snapshot of the UI element in a current position of a previously in progress transition and animating the transition from the UI element's current size and position to the UI element's new ending size and position based on the incoming state.

6. The method of claim 1 wherein comparing further comprises using a comparison result to create a series of intermediate positions and appearances for the UI element to provide a smooth animation transition from the outgoing state to the incoming state.

7. The method of claim 1 wherein animating the transition comprises determining a number of intermediate appearances based on a specified duration for the transition between states.

8. The method of claim 1 wherein animating the transition comprises determining a property type that changed, and for a color property type animating the red, green, and blue values gradually between a start color and an end color.

9. The method of claim 1 wherein animating the transition comprises determining a property type that changed, and for a layout property change that modifies the UI element's position, gradually modifying the coordinates of the UI element to produce smooth movement.

10. The method of claim 1 wherein animating the transition comprises determining a property type that changed, and for a visibility property, gradually modifying an opacity property to create an appearance of smoothly changing visibility.

11. The method of claim 1 further comprising before animating the transition wrapping the UI element in a temporary container that isolates the movement of the UI element during animation from other UI elements, and after animating the transition removing the temporary container from the UI element so that the UI element is placed back into its normal position in the layout hierarchy and so that any modifications to it will once again affect surrounding elements.

12. A computer system for smoothly animating user interface (UI) transitions between states, the system comprising:
a processor and memory configured to execute software instructions;
a state management component configured to store multiple states in which a UI can exist and receive an indication to transition from one state to another;
a determine state delta component configured to compare an ingoing and outgoing state to determine layout properties that change between the states, and corresponding UI elements that will change;
a state snapshot component configured to take a snapshot of an area within which each corresponding UI element of a layout is positioned;
a snapshot comparison component configured to compare snapshots of an incoming state and an outgoing state to determine what UI elements change and identify property values for appearance properties at each state; and
an element animation component configured to animate each element smoothly between the outgoing state and incoming state by displaying one or more intermediate appearances for each element.

13. The system of claim 12 wherein the state management component is further configured to store states in a declarative format that can be edited by a designer without programming experience, wherein the declarative format also contains transition information that includes at least conditions that cause a transition and a duration of the transition.

14. The system of claim 12 wherein at least one property of the layout properties compared by the determine state delta component is selected from the group consisting of a column of a grid layout, a row of a grid layout, a row span of a grid layout, a column span of a grid layout, a top property of a canvas, a left property of a canvas, a visibility property, an orientation of a stack, a docking direction in a dock layout, an expanded property of an expander layout, an orientation of a wrap panel layout, an item width of a wrap panel layout, an item height of a wrap panel layout, a width property, a height property, a minimum width property, a minimum height property, a maximum width property, a maximum height property, a margin property, a padding property, a horizontal alignment property, and a vertical alignment property.

15. The system of claim 12 wherein the determine state delta component is further configured to add parent and sibling elements of each corresponding UI element to a set of UI elements that change.

16. The system of claim 12 wherein the snapshot comparison component is further configured to determine a value of each property that changed between the incoming state and the outgoing state, and to determine an appropriate property for the element animation component to modify to simulate the transition of the property that changed.

17. The system of claim 12 further comprising an element isolation component configured to isolate movement of a UI element from other UI elements during animation.

18. A computer-readable storage medium comprising instructions for controlling a computer system to identify potential target user interface (UI) elements in a layout that may change appearance during a UI state transition, wherein the instructions, when executed, cause a processor to perform actions comprising:
comparing an outgoing state to an incoming state to determine layout-based properties that are different between the outgoing state and the incoming state;
identifying changed layout properties based on the comparison;
storing changed UI elements that have identified changing layout properties in a data structure;
for each UI element identified, adding sibling and parent UI elements to the stored UI elements; and
smoothly animating a transition of each identified UI element between an appearance of the element when the element is in the outgoing state and an appearance of the element when the element is in the incoming state.

19. The medium of claim 18 wherein the method stores at least one UI element that has changing layout properties based on the comparison but that does not change appearance between the outgoing state and the incoming state.

20. The medium of claim 18 further comprising for at least one UI element in the layout not stored in the data structure, animating the transition of the UI element in parallel with layout animations by modifying at least one property of the UI element not based on a geometric position of the UI element.
